(19) United States
(12) Patent Application Publication
(10) Pub. No.: US 2002/0176608 A1
(43) Pub. Date: Nov. 28, 2002

(54) Surface-profiling system and method therefor

(76) Inventor: David Walter Rose, Glendale, AZ (US)

Correspondence Address: Lowell W. Gresham, MESCHKOW & GRESHAM, P.L.C., 5727 N. Seventh Street, Suite 409, Phoenix, AZ, 85014, US

(21) Appl. No.: 09/864,105

(22) Filed: May 23, 2001

(51) Int. Cl. G06K 9/00

(52) U.S. Cl. 382/108

(57) ABSTRACT

A surface-profiling system (20) and a process (32) for implementing same are presented. The system (20) incorporates a vehicle (40) configured to move upon a surface (24). A projector (38) is affixed to the vehicle (40) and configured to project two-dimensional patterns (22) at a first angle (52) substantially perpendicular to the surface (24). A camera (48) is also affixed to the vehicle (40) and configured to capture images (50) of the projected patterns (22) from a second angle (54) oblique to the surface (24) as the vehicle (40) moves over the surface (24). A computer (72) is configured to produce a transverse profile (26) of the surface (24) from each captured image (50) and configured to derive a longitudinal profile (28) of the surface (24) from a series (126) of the transverse profiles (26).

### TECHNICAL FIELD OF THE INVENTION

The present invention relates to the field of surface profiling. More specifically, the present invention relates to the field of non-contact surface profiling using light.

### BACKGROUND OF THE INVENTION

This discussion focuses primarily upon road surfaces. Those skilled in the art will appreciate that this discussion applies equally to any surface intended for vehicular traffic. These surfaces include, but are not limited to, highways, roads, ramps, parking, and service areas for ground vehicles (trucks, cars, busses, etc.), runways, taxiways, parking aprons, and hangar floors for aircraft, and tracks and roadbeds for railroads. The terms “road” and “road surface,” as used herein, refer specifically to “a road” and “a surface of a road,” respectively, and refer generally to “a way or course for ground, air, or rail vehicles” and “a surface of a way or course,” respectively.

The public generally expects a road surface to provide a smooth, comfortable, and quiet ride at all times, inhibit splash and spray when wet, reduce glare at night or when the sun is low, provide good visibility under varying constraints of weather, resist wear and tear to itself, inhibit wear and tear to vehicles, and to generally be safe under all conditions, including bad driving. This expectation may be overly optimistic.

Roads wear over time. As a road wears, roughness, potholes, rutting, and other signs of distress appear. Road distress directly affects the comfort and safety of the ride. Roughness and potholes impede the comfort and safety of the ride by causing the wheels of a vehicle to intermittently lose contact with the surface, thereby reducing overall traction. This effect is especially detrimental when the road is wet and/or slippery, as in inclement weather. Additionally, road distress may reduce a driver's ability to control the vehicle. For example, a pothole may cause a vehicle to suddenly veer in an unexpected direction, ruts may collect water and cause hydroplaning, and ruts may cause a vehicle to tend to follow the ruts when the driver attempts to steer the vehicle elsewhere.

In the industry, road condition is measured by profiling. Profiling is the obtaining of a profile or series of profiles of the road surface. A profile is substantially a cross-sectional view of the surface of the road. A profile depicts the contours of the road, thereby demonstrating the form, wear, and irregularities of the road surface.

A transverse profile is a cross-sectional view of the road surface or a portion thereof taken substantially perpendicular to the direction of travel. A transverse profile may be used to depict rutting, potholes, scaling, chipping, and edge damage of the road surface over time.

A longitudinal profile is a cross-sectional view taken substantially in the direction of travel. A longitudinal profile may be used to depict the grade, waviness, and roughness of the road surface. Longitudinal profiles may be used to monitor the wear of the road surface over time to facilitate maintenance planning.

Profiles may be taken manually by actually measuring the contour of the road surface with surveying and measuring instruments. Manual profiling is time consuming and requires full or partial closure of the road.

High-speed profiling systems, i.e., profilers, have been developed that can capture longitudinal and/or transverse profiles at speed. Such profilers are made up of profile measuring instrumentation mounted into and/or on a vehicle (e.g., a car, a van, a light truck, or a trailer).

A typical road has two wheelpaths per lane, i.e., the paths of a majority of the wheels passing over the road, and in which the majority of the wear occurs. A response-type profiler incorporating a transducer attached to a vehicle wheel was developed to obtain a longitudinal profile of a wheelpath. Since only one wheel was monitored, this is known as a “quarter-car” profiler.

The longitudinal profile captured by a quarter-car response-type profiler was used as a basis for standardization of road roughness. The International Roughness Index (IRI) and the Ride Number (RN) are two such roughness standards.

Multipoint response-type profilers have been developed that produce a plurality of longitudinal profiles of the road in a single pass. Such profilers are often self-referencing. The portions of the road surface not in a wheelpath remain substantially unworn over the life of the road. Longitudinal profile of these substantially unworn portions may be used to establish a reference height and camber for the road surface.

The accuracy of data derived from a response-type profiler suffers from tire and transducer variables. To eliminate these variables, non-contact profilers have been developed. One form of non-contact profiler is the rut-bar profiler.

In a rut-bar profiler, a plurality of range finders is mounted to a bar (the rut bar) affixed to a vehicle and suspended above the road surface. Each range finder is configured to determine the substantially vertical distance from the rut bar to the road surface. Typical rut-bar profilers have at least five range finders, with one undesirably complex and expensive model having up to twenty-one.

A rut-bar profiler may use ultrasonic range finders, which determine the bar-to-road distance by measuring the time between the transmission of an ultrasonic pulse and the reception of its echo. The time between transmission of the ultrasonic pulse and the reception of its echo is significant, however, and limits the maximum speed of the vehicle if the resultant profile is to meet the IRI and/or RN standards.

Alternatively, a non-contact rut-bar profiler may use laser range finders to measure the distance between the rut bar and the road surface. In a laser range finder, a small laser spot is projected onto the surface at one angle and an optical sensor measures the position of the spot from a slightly different angle. This allows the distance from the rut bar to the road surface to be measured with great accuracy.

The spot from a laser range finder tends to be very small. This small spot may fall upon and between the aggregate used in the road surface, resulting in errors in the bar-to-road measurements.

In some embodiments, the beam from a laser range finder is not generally eye safe. This poses a hazard to an operator and to other proximate personnel should the beam strike a reflective object in or on the surface.

The outside longitudinal profiles of a typical multipoint profiler must be captured well outside the wheelpaths. The mounting of a sensor or range finder well outside the wheelpaths creates a traffic obstruction and potential road hazard. For a laser rut-bar profiler, however, the rut bar may be made smaller and the outside range finders tilted so that the spots therefrom strike the pavement beyond the width of the rut bar. However, this increases the bar-to-road distance and decreases the accuracy of those range finders.

For all of the aforementioned response-type and rut-bar profilers to capture a relevant longitudinal profile, it is necessary that the profile be captured at the exact center of the wheelpath. This is not practical over extended periods and at highway speeds. Multiple captures over the same stretch of road have produced longitudinal profiles with significant variations in roughness and wear, where such differences are due primarily to the position of the vehicle during the capture.

With longitudinal profiles, the resolution is a function of the sample rate. To meet international standards, the sample rate should be coordinated with the vehicle speed to produce a resolution of one datum per ten centimeters.

The resolution of a transverse profile, however, is independent of the sample rate. The resolution is a function of the number and positioning of the sensors. All the aforementioned profilers produce poor transverse profiles. Assuming equal sensor spacing over a typical highway lane, a typical five-sensor multipoint profiler produces a resolution of one datum approximately every eighty centimeters, while a twenty-one sensor rut-bar profiler produces a datum every twenty centimeters. This represents a transverse profile resolution that is at best half the granularity of a longitudinal profile.

In cases where an improved transverse resolution is desired, an optical-line profiler may be used. An optical-line profiler uses a projector to project a line of light across the road at a one angle and a camera to capture an image of that line at a slightly different angle. The angles and geometries of the projector and camera being known, triangulation may then be used to compute the projector-to-road difference for any desired number of transverse points, i.e., at any desired transverse resolution.

A projected line must be quite bright, however, to provide sufficient contrast between the lit and unlit portions of the resultant image. If a laser is used, this brightness may not be eye safe, thereby posing a health hazard.

An optical-line profiler projects a transverse line that is typically very thin in the longitudinal direction. As with a laser rut-bar sensor, this thin line may fall upon and between the aggregate used in the road surface, resulting in erroneous projector-to-road measurements. These measurements are limited to the nearest pixel, additionally reducing accuracy. The resultant captured profile may be irrelevant to the actual road profile.

Additionally, optical-line profilers produce a line-base “pattern” than may easily be confused by paint stripes, bright pieces of aggregate, and/or debris. Such objects may introduce sufficient noise to produce inaccurate results.

### SUMMARY OF THE INVENTION

Accordingly, it is an advantage of the present invention that a surface-profiling system and method therefor is provided.

It is another advantage of the present invention that a surface-profiling system and method are provided that utilize a two-dimensional pattern to obtain a transverse profile.

It is another advantage of the present invention that a non-contact surface-profiling system and method are provided which exhibits improved accuracy in the capture of longitudinal profiles.

It is another advantage of the present invention that a vehicle-mounted surface-profiling system and method are provided that capture longitudinal profiles while the vehicle is driving at speed.

It is another advantage of the present invention that a profiling system is provided that does not protrude beyond the width of the vehicle to which it is attached, thereby increasing the safety of operation.

The above and other advantages of the present invention are carried out in one form by a surface-profiling method incorporating projecting a two-dimensional pattern of alternating relatively lighter and relatively darker regions upon a surface at a first angle relative to the surface, capturing an image of the pattern from a second angle relative to the surface, and processing the image to produce a profile of the surface.

The above and other advantages of the present invention are carried out in another form by a surface-profiling system incorporating a projector configured to project a two-dimensional pattern of alternating relatively lighter and relatively darker regions upon a surface from a first angle, a camera configured to capture an image of the projected pattern from a second angle, and a computer configured to produce a profile of the surface from the captured image.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a surface-profiling system in accordance with a preferred embodiment of the present invention;

FIG. 2 shows a two-dimensional pattern projected upon a road surface by the system of FIG. 1;

FIG. 3 shows the derivation of a transverse profile from the two-dimensional pattern of FIG. 2;

FIG. 4 shows a single image region from FIG. 3;

FIG. 5 shows the derivation of a longitudinal profile from a series of the transverse profiles of FIG. 3;

FIG. 6 shows a composite pattern containing a plurality of two-dimensional patterns and projected upon a road surface by an alternative embodiment of the system of FIG. 1;

FIG. 7 depicts a surface-profiling process for use with the system of FIG. 1 in accordance with a preferred embodiment of the present invention; and

FIG. 8 depicts a subprocess of the process of FIG. 7 to obtain the transverse profile of FIG. 3.

### DETAILED DESCRIPTION OF THE PREFERRED EMBODIMENTS

Throughout this discussion the terms “length,” “width”, and “height” are used to describe dimensions or directions. All such dimensions or directions are made relative to the surface of a hypothetical straight road. Any “length” dimension or direction is substantially longitudinally parallel to the road surface (i.e., along the road). Any “width” dimension or direction is substantially perpendicular to “length” dimensions or directions and substantially transversely parallel to the road surface (i.e., across the road). Any “height” dimension or direction is substantially perpendicular to both “length” and “width” dimensions and substantially perpendicular to the road surface (i.e., into the road).

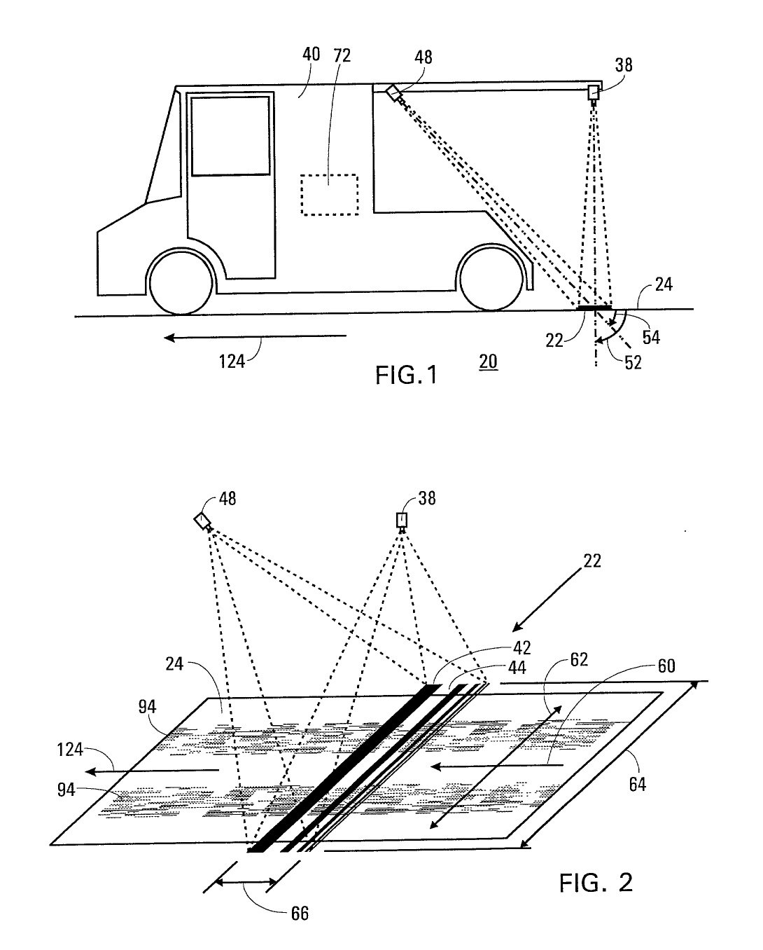

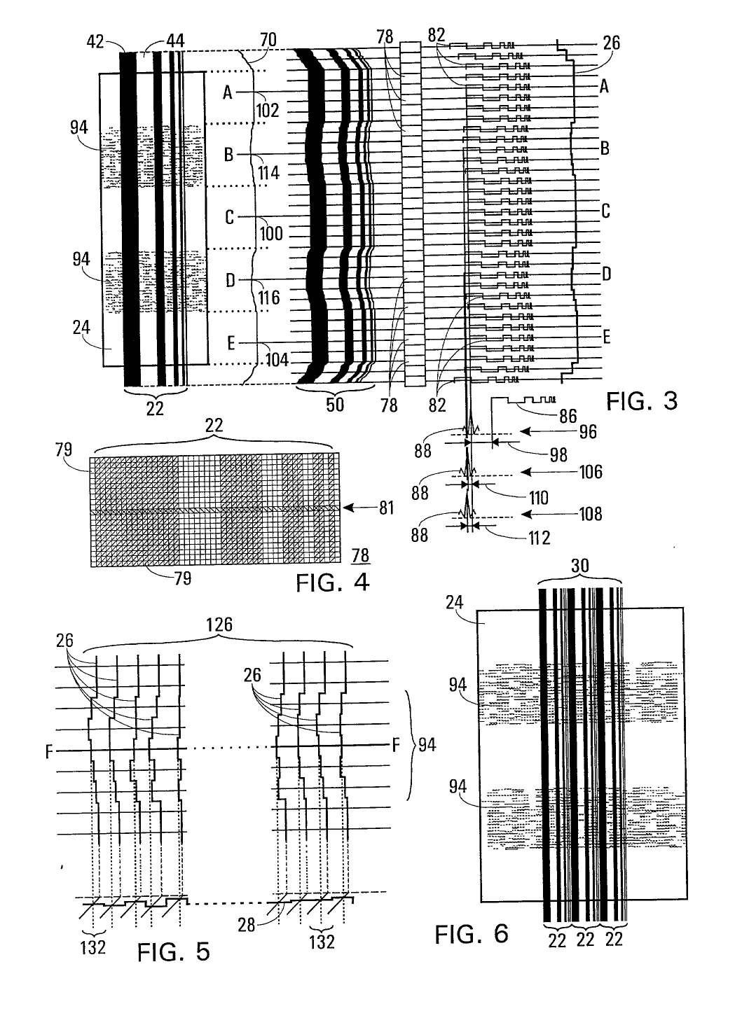

FIG. 1 shows a surface-profiling system 20 in accordance with a preferred embodiment of the present invention. FIG. 2 shows a two-dimensional pattern 22 projected upon a surface 24 by system 20. FIG. 3 shows the derivation of a transverse profile 26 from two-dimensional pattern 22. FIG. 4 shows an enlargement of a single image region 78. FIG. 5 shows the derivation of a longitudinal profile 28 from a series of transverse profiles 26. FIG. 6 shows a composite pattern 30 containing a plurality of two-dimensional patterns 22 and projected upon surface 24 by an alternative embodiment of system 20.

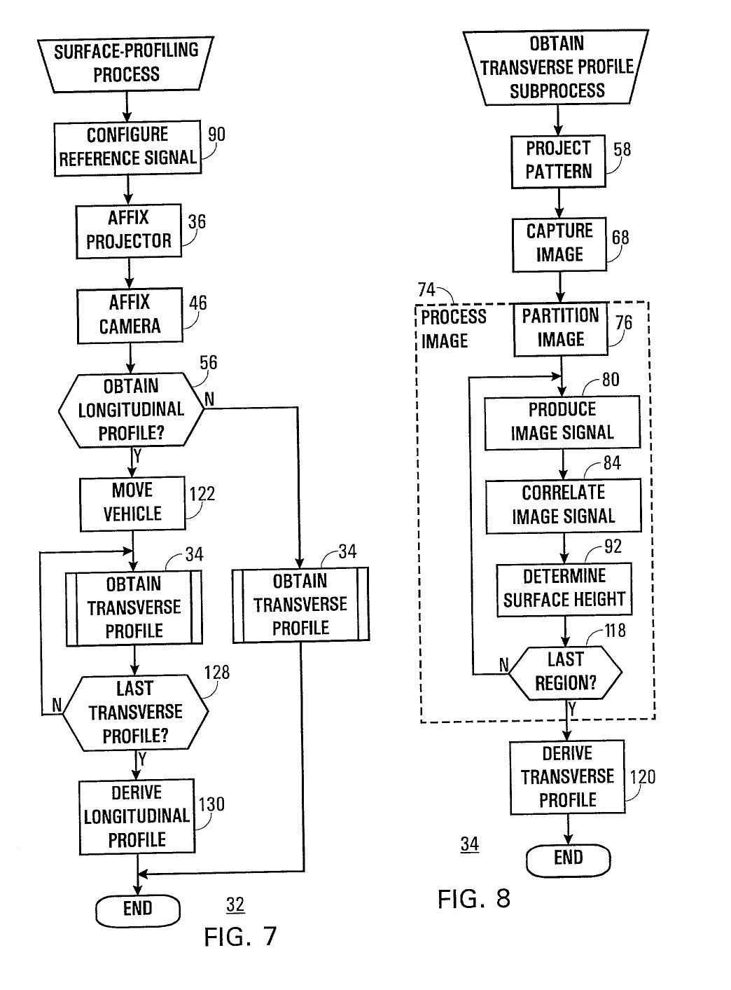

FIG. 7 depicts a surface-profiling process 32 for use with system 20 in accordance with a preferred embodiment of the present invention. FIG. 8 depicts a subprocess 34 of process 32 to obtain transverse profile 26.

This discussion uses the term “surface” to describe any embodiment of surface 24 intended for vehicular traffic. These surfaces 24 include, but are not limited to, highways, roads, ramps, parking, and service areas for ground vehicles (trucks, cars, busses, etc.), runways, taxiways, parking aprons, and hangar floors for aircraft, and tracks and roadbeds for railroads. For purposes of simplicity, surface 24 is addressed herein as though surface 24 is a road surface unless specified otherwise.

Referring to FIGS. 1-5 and 7, surface-profiling process 32 describes the basic tasks used to obtain transverse profile(s) 26 and/or a longitudinal profile 28 through the use of surface-profiling system 20.

System 20 is a vehicular-mounted system. That is, components of system 20 are mounted upon and/or inside of a vehicle 40. The type of vehicle to be used for vehicle 40 is not relevant to the present invention, and a wide assortment of vehicles, from hand carts, though golf carts, cars, trucks, railroad cars, and even aircraft may be used. The choice of vehicle is dependent upon the manner in which system 20 is to be used and the type of surface 24 to be profiled. FIG. 1 depicts vehicle 40 as a truck for exemplary purposes only.

A projector 38 is affixed to vehicle 40 in a task 36. Projector 38 is affixed so that projector 38 may project two-dimensional pattern 22 upon surface 24. Two-dimensional pattern 22 is formed of a plurality of relatively lighter areas 42 alternating with relatively darker areas 44.

Those skilled in the art will appreciate that, due to the constraints of line drawings, FIGS. 2, 3, and 6 substantially depict lighter areas 42 as black lines and substantially darker areas 44 as the spaces between the black lines. In other words, pattern 22 is depicted in FIGS. 2, 3, and 6 in a negative manner.

In a preferred embodiment, the luminosity of a given portion of pattern 22 is binary. That is, relatively lighter areas 42 are those portions of pattern 22 which are illuminated by light from projector 38 and relatively darker areas 44 are those portions of pattern 22 which are not illuminated by light from projector 38. One method of projecting pattern 22 with the desired binary luminosity is to use a computer-controlled laser or other monochromatic light source. Another method is to use a stroboscopic light source, such as a laser, to project indiscriminately through a binary mask.

In an alternative embodiment, the luminosity of a given area of pattern 22 is analog. That is, the luminosity of a given area is some quantity of luminous flux from projector 38, which flux varies from a maximum luminosity to a minimum luminosity. In this case, relatively lighter areas 42 are those portions of pattern 22 which are illuminated by more than a mean luminosity by projector 38 and relatively darker areas 44 are those portions of pattern 22 which are illuminated by less than a mean luminosity by projector 38. One method of projecting pattern 22 with the desired analog luminosity is to modulate a swept laser or other light source.

Those skilled in the art will appreciate that the binary and analog projection methodologies discussed hereinbefore are exemplary, and that other projection methodologies not discussed herein may also be used. The use of a particular projection methodology does not depart from the spirit of the present invention. For purposes of simplicity, this discussion assumes that projector 38 projects two-dimensional pattern 22 using the aforementioned binary methodology. Pattern 22 is so depicted in FIGS. 2, 3, and 6.

Referring to FIGS. 1-3 and 7, a camera 48 is affixed to vehicle 40 in a task 46. Camera 48 is affixed so that camera 48 may capture an image 50 of two-dimensional pattern 22 upon surface 24.

As depicted in FIG. 1, projector 38 is configured to project two-dimensional pattern 22 onto surface 24 at a projection angle 52, and camera 48 is configured to capture image 50 of pattern 22 at a capture angle 54. In the preferred embodiment, projection angle 52 is substantially perpendicular to surface 24, though this is not a requirement of the present invention. Capture angle 54 is not equal to projection angle 52 and, in the preferred embodiment, is oblique to surface 24.

Those skilled in the art will appreciate that projector 38 and camera 48 are preferably mounted along a centerline of vehicle 40 extending in the direction of vehicular travel (not shown), though this is not a requirement of the present invention. Other mounting locations may be used as long as the positional relationships between projector 38, camera 48, and pattern 22 upon surface 24 are understood and compensated for.

Additionally, those skilled in the art will appreciate that some implementations may involve multiple projectors 38 and/or cameras 48. For example, a railroad implementation may be used where a first projector 38 and camera 48 are mounted proximate and above a first surface 24, being a first rail, a second projector 38 and camera 48 are mounted proximate and above a second surface 24, being a second rail, and a third projector 38 and camera 48 are mounted above a third surface 24, being a roadbed. With this triple embodiment of surface-profiling system 20, both rails and the roadbed may be profiled in one pass of vehicle 40. This and other variant embodiments may be incorporated into system 20 without departing from the spirit of the present invention.

Referring to FIGS. 3, 5, 7, and 8, process 32 determines in a decision task 56 if longitudinal profile 28 of surface 24 is to be obtained. If longitudinal profile 28 is not to be obtained, then process 32 executes a subprocess 34 to obtain transverse profile 26.

Referring to FIGS. 1-4 and 8, projector 38 projects two-dimensional pattern 22 onto surface 24 in a task 58. Surface 24 has a longitudinal direction 60, being the direction in which vehicle 40 and other vehicles would normally traverse surface 24, and a transverse direction 62 substantially at right angles to longitudinal direction 60. Two-dimensional pattern 22 as projected upon surface 24 has a width 64 measured substantially in transverse direction 62 and a length 66 measured substantially in longitudinal direction 60.

Two-dimensional pattern 22 is formed of a plurality of relatively lighter areas 42 alternating with relatively darker areas 44. Preferably, alternating relatively lighter and darker areas 42 and 44 are stripes across width 64 of pattern 22. More preferably, the stripes of pattern 22 are arranged so that pattern 22 is a high-correlation pattern. That is, pattern 22 is a series of alternating relatively lighter and darker areas 42 and 44 arranged as stripes and configured to have a mathematical autocorrelation function that is high at zero translation (i.e., in the longitudinal direction) and low everywhere else (discussed hereinafter). Examples include spatial chirp patterns, Barker-code patterns, pseudo-random binary patterns and many other patters well known to those skilled in the art. The exemplary pattern 22 depicted in FIGS. 2 and 3 is a chirp pattern.

Camera 48 captures image 50 of pattern 22 in a task 68. As is well known in the art, surface 24 is not precisely flat. In the exemplary embodiment of FIG. 3, surface 24 is assumed to have a real, physical contour as described by curve 70. If, as is preferred, projector 38 projects pattern 22 at projection angle 52 substantially perpendicular to surface 24, and camera 48 captures image 50 of pattern 22 at capture angle 54 oblique to surface 24, image 50 of pattern 22 will be distorted to conform to the physical contour of surface 22. That is, image 50 will be pattern 22 as distorted by physical contour curve 70.

System 20 incorporates a computer 72 coupled to camera 48. In a supertask 74, computer 72 processes image 50.

Within supertask 74, a task 76 partitions image 50 into image regions 78. Each image region 78 represents the smallest portion of image 50 that may be processed. In other words, the number of image regions 78 establishes the resolution of image 50, and therefore the detail ultimately to be contained within transverse profile 26.

Those skilled in the art will appreciate that an image region 78 represents solely the desired smallest portion of image 50 that is to be processed, and is not dependent upon the resolution of (i.e., the number of pixels within) camera 48. Desirably, camera 48 has much higher resolution than the desired resolution of image 50. This is illustrated in FIG. 4, wherein a single image region 78 is shown to have a width of an arbitrary number of pixels 79. Indeed, depending upon the desired resolution of image 50 and the resolution of camera 48, image region 78 may be anywhere from one to hundreds of pixels 79 in width. The length of image region 78 needs have at least a number of pixels 79 sufficient to contain pattern 22. Maximum resolution of image 50 is obtained when the image resolution equals the camera resolution, i.e., when image region 78 is one pixel 79 in width In this special case, image region 78 is reduced to a single pixel column 81.

Those skilled in the art will also appreciate that each image region 78 is spread over length 66 of pattern 22. When length 66 of pattern 22 is made substantially equal to the length of a tire footprint and the width of an individual image region 78 is made to approximate the width of the tire footprint, then the area of surface 24 encompassed by that image region 78 is substantially equal to that of the tire footprint and system 20 may be made to emulate a quarter-car or other response-type profiler.

For the sake of simplicity, image 50 is graphically portrayed in FIG. 3 as being divided into thirty-three image regions 78. Those skilled in the art will appreciate that the number of image regions 78 is somewhat arbitrary. In practice, image 50 is preferably divided into more than twenty-five image regions so that the edges and centers of wheelpaths 94 may be readily identified. This becomes more desirable when longitudinal profiles #28 are to be captured (discussed hereinafter).

Under some conditions, it may be desirable to divide image 50 into hundreds or even thousands of image regions 78. Such a fine resolution would allow system 20 to achieve the transverse-profile accuracy heretofore achievable through manual profiling.

It will be appreciated, however, that system 20 is not restricted to high-resolution profiling. For example, it may be desirable for system 20 to be reduced to a single image region 78 having a width and length approximating the footprint of a tire. This embodiment (not shown) would allow system 20 to emulate a standard “quarter-car” profiler, thereby producing data that may be readily compared to historical data obtained with such a profiler. Similarly, two image regions 78 may be used to emulate a “half-car” profiler, and three image regions 78 may be used to emulate a “rut-wear” profiler.

A task 80 produces an image signal 82 for one image region 78 of image 50. A task 84 then correlates that image signal 82 with a reference signal 86 to produce a correlation signal 88.

Referring momentarily to FIGS. 1-3 and 7, reference signal 86 corresponds to pattern 22 as projected by projector 38 in task 58. Since pattern 22 need not vary, reference signal 86 is desirably an electronic analog of pattern 22 stored in computer 72. Since reference signal 86, like pattern 22, need not change, reference signal 86 may be configured in a task 90 ahead of decision task 56 in process 32. That is, task 90 to configure reference signal 86, like tasks 36 and 46 to affix projector 38 and camera 48 to vehicle 40, may be considered a part of the set-up or initialization of system 20.

Referring again to FIGS. 1-4 and 8, task 92 determines the relative height of surface 24 within one image region 78. Image region 78 may be taken to be a subset of image 50 (as discussed hereinbefore) in the width or transverse direction encompassing the entirety of image 50 (i.e., pattern 22) in the length or longitudinal direction. In simplified form, task 92 is demonstrated in FIG. 3. Lines A-A, B-B, C-C, D-D, and E-E represent cross sections of image 50 as captured by camera 48. Due to the difference between projection angle 52 and capture angle 54 (FIGS. 1 and 2), i.e., between the positions of projector 38 and camera 48 relative to the position of pattern 22 upon surface 24, the location of pattern 22 within image 50 is a function of the height of surface 22. More specifically, pattern 22 at each point in image 50 will appear to be offset longitudinally by a distance substantially proportional to the height of surface 24 at that point. In order to determine the height of surface 24 at any given point, therefore, it is necessary to determine the longitudinal offset of pattern 22 at that given point.

Image regions 78 represent the resolution or “granularity” of image 50 within system 20. To locate the longitudinal offset of pattern 22 within a given image region 78, task 92 correlates pattern 22 within that image region 78 with reference signal 86 to produce correlation signal 88. Correlation signal 88 for image region 78 on line C-C is depicted in correlation diagram 96. Correlation signal 88 for line C-C has a peak whose position is a function of a longitudinal offset 98 of image signal 82 at line C-C. Line C-C longitudinal offset 98 determines the relative height 100 of surface 24 where physical contour curve 70 is intersected by line C-C.

The correlation of pattern 22 in any given image region 78 is not a function of the specific pattern 22 used. It will be appreciated that, in theory, any two-dimensional pattern may be used for pattern 22. In the preferred embodiment, however, it is most desirable that pattern 22 be a high-correlation pattern. That is, pattern 22 is desirably configured to have a mathematical autocorrelation function that is more efficient in the longitudinal direction and less efficient in all other directions. Desirably, the ratio of the peak of correlation signal 88 in the longitudinal direction to the second highest peak of correlation signal 88 is as high as possible. It is also desirable that the width of the peak of correlation signal 88 in the longitudinal direction be as narrow as possible. The use of patterns having these desirable characteristics increases the accuracy and noise immunity of system 20. The hereinbefore-discussed spatial chirp, Barker-code, and pseudo-random binary patterns are exemplary of the preferred form of pattern 22.

Tasks 80, 84, and 92 process data for one image region 78 at a time. Initially, tasks 80, 84, and 92 process a first image region 78. A decision task 118 then determines if a last image region 78 has been processed. If task 118 determines that the last image region 78 has not been processed, then tasks 80, 84, and 92 are repeated to process a next image region 78. This continues until task 118 determines that the last image region 78 has been processed. At this time, image-processing supertask 74 has been completed and computer 72 contains the data for all image regions 78 in memory.

A task 120 then derives transverse profile 26 from the data for each image region 78. Task 92 determined the relative height of surface 24 in each image region 78. An analysis to these relative heights determines the locations of wheelpaths 94 and the overall contour of surface 24. This may be demonstrated using the image regions 78 on lines A-A, B-B, C-C, D-D, and E-E as representative image regions 78.

In simplified form, line C-C represents a specific image region 78 located between wheelpaths 94, i.e., over a substantially unworn central portion of surface 24. Correlation signal 88 for this image region 78 is depicted in correlation diagram 96. Since correlation diagram 96 represents a substantially unworn portion of surface 24, correlation diagram 96 represents a reference for surface 24. This is in keeping with system 20 being self-referencing.

Correlation signal 88 for line C-C has a peak that is a function of the displacement of image signal 82 for line C-C. The offset 98 between image signal 82 for path C-C and reference signal 86 establishes C-C height 100 for surface 24. C-C height 100 is depicted as the point on physical contour curve 70 intersected by line C-C.

The simplified surface 24 of FIG. 3 is assumed to be substantially flat except where surface 24 has been worn by the passage of various vehicles, i.e., in wheelpaths 94, and off the edges of surface 24. Because of this assumed flatness, lines A-A and E-E represent image regions 78 outside of wheelpaths 94, i.e., over substantially unworn outer portions of surface 24. Correlation signals 88 for these image regions 78 are also depicted in correlation diagram 96. Paths A-A and E-E establish height 102 and 104, depicted as the point on physical contour curve 70 intersected by line A-A and E-E, respectively.

Those skilled in the art will appreciate that surface 24 is rarely flat. Indeed, a flat surface 24 is markedly undesirable under most circumstances. In practice, A-A height 102, C-C height 100, and E-E height 104 are used to establish a reference contour (not shown) of surface 24. That is, heights 102, 100, and 104 are used to determine the contour surface 24 would have if substantially the entirety of surface 24 were to be substantially unworn. It will also be appreciated that any number of desired “reference” heights may be determined to aid in the establishment of the reference contour of surface 24.

Once reference height 100 (or the reference contour) has been established, correlation signals 88 for image regions 78 in paths B-B and D-D are depicted in correlation diagrams 106 and 108 respectively. The offsets 110 and 112 between image signals 82 for paths B-B and D-D and reference image signal 86 for path C-C establishes B-B and D-D heights 114 and 116, respectively, relative to reference (C-C) height 100 (or the reference contour). B-B and D-D heights 114 and 116 are depicted as the points on physical contour curve 70 intersected by lines B-B and D-D. Lines B-B and D-D are located proximate the midpoints of wheelpaths 94, i.e., over those portions of surface 24 that experience the greatest wear. Therefore, B-B height 114 and D-D height 116 are dependent upon the wear of surface 24.

Referring to FIGS. 1, 2, 5, and 7, if decision task 56 determined that longitudinal profile 28 was to be obtained (captured), then in a task 122 vehicle 40 is moved over the desired portion of surface 24 in a vehicular direction 124. Vehicular direction 124 is substantially coincident with longitudinal direction 60 of surface 24.

As vehicle 40 transits substantially equal distances (not shown) over surface 24, subprocess 34 is repetitively executed to capture a transverse profile 26 of surface 24 at each equal distance. This produces a series 126 of transverse profiles 26.

A first such transverse profile 26 is captured where it is desirous that longitudinal profile 28 is to begin. A decision task 128 then determines if a last required transverse profile 26 has been captured, i.e., if the desired end of longitudinal profile 28 has been reached.

If decision task 126 determines that the last required transverse profile 26 has not been captured, then subprocess 34 is executed to capture the next transverse profile 26.

If decision task 126 determines that the last required transverse profile 26 has been captured, then a task 130 derives longitudinal profile 28 from transverse-profile series 126.

FIG. 5 depicts transverse-profile series 126 wherein each transverse profile 26 encompasses a wheelpath 94. A line F-F is proximate the center of wheelpath 94. The position of each transverse profile 26 at line F-F is a function of the height of surface 24 in that image region 78 at the position where transverse profile 24 was captured. By converting each F-F image region 78 of each consecutive transverse profile 26 into a consecutive image region 132 of a longitudinal profile 28, the resultant longitudinal profile 28 will show the region-by-region profile of surface 24 along line F-F.

If desired, as discussed hereinbefore, a given image region 78 may be made to emulate a tire footprint. If, in each transverse profile 26 in series 126 the image regions 78 at lines A-A, B-B, C-C, D-D, and E-E are made to emulate a tire footprint, then system 20 will effectively emulate a multipoint response-type profiler. Those skilled in the art will appreciate that any desired number of points may be emulated.

As mentioned hereinbefore, transverse profiles 26 may be captured with any desired resolution. If transverse profiles 26 are captured with a sufficient number of image regions 78 per image 50 (i.e., with a high enough resolution), then a determination of center and edges of each wheelpath 94 may readily be made by computer 72. When capturing a longitudinal profile 28, a determination of the position of wheelpaths 94 in each transverse profile 26 in series 126 allows electronic alignment of wheelpaths 94. This produces longitudinal profiles 28 that are highly repeatable over multiple passes, even when those passes are separated by a significant time, e.g., months or even years, and even when the exact position of system 20 is not identical for each pass. It has been determined that a system 20 having at least twenty-five such image regions 78 per transverse profile 26 is capable of producing appropriate electronic wheelpath alignment. Those skilled in the art will appreciate that this is an arbitrary number denoting a minimum desired accuracy, and that in practice hundreds of image regions 78 per transverse profile 26 may be used to produce highly accurate wheelpath alignment.

The following discussion refers to FIGS. 1 and 6. The International Roughness Index (IRI) is a standard for longitudinal profiles 28. The IRI standard requires a resolution of ten centimeters. That is, to produce a longitudinal profile 28 that meets the IRI standard, an image 50 of two-dimensional pattern 22 must be captured every ten centimeters along surface 24. At a highway speed of 75 miles per hour (3352.8 centimeters per second), an image 50 must be captured every 2.9826 milliseconds, or better than 335 images 50 must be captured per second. This represents a challenge in terms of the rapidity with which camera 48 must capture images 50.

In order to reduce the number of images 50 to be captured per second, projector 38 may project a composite pattern 30 containing multiple two-dimensional patterns 22. Camera 48 may then capture multiple patterns 22 simultaneously. With the triple-pattern composite 30 depicted in FIG. 6, slightly less than 112 images per second need be captured at a speed of 75 miles per hour for vehicle 40. This represents a significant reduction in the number of images 50 that need be captured per second. Of course, it will be appreciated that the triple pattern composite 30 of FIG. 8 is exemplary only, and composite patterns 30 having ten or more patterns 22 are entirely feasible.

In summary, the present invention teaches a surface-profiling system 20 and a process 32 to implement system 20. Surface-profiling system 20 and method 32 utilize a two-dimensional pattern 22 to obtain a transverse profile 26 of any desired resolution. Surface-profiling system 20 is a non-contact profiling system that may emulate a response-type profiler in the capture of longitudinal profiles 28. Surface-profiling system 20 is a vehicle-mounted system that captures longitudinal profiles 28 while a vehicle 40 is traversing surface 24 at speed.

Although the preferred embodiments of the invention have been illustrated and described in detail, it will be readily apparent to those skilled in the art that various modifications may be made therein without departing from the spirit of the invention or from the scope of the appended claims.

What is claimed is:

1. A surface-profiling method comprising:
projecting a two-dimensional pattern of alternating relatively lighter and relatively darker regions upon a surface at a first angle relative to said surface;
capturing an image of said pattern from a second angle relative to said surface; and
processing said image to produce a profile of said surface.

2. A surface-profiling method as claimed in claim 1 wherein:
said projecting activity projects discrete multiple ones of said patterns;
said capturing activity captures an image of each of said patterns; and
said processing activity processes each of said images.

3. A surface-profiling method as claimed in claim 1, wherein said pattern has a length and a width, said method additionally comprising:
affixing to a vehicle a projector configured to effect said projecting activity, wherein said vehicle is configured to move in a vehicular direction and said projector is configured to project said pattern so that said width is substantially perpendicular to said vehicular direction;
affixing to said vehicle a camera configured to effect said capturing activity; and
moving said vehicle over said surface in said vehicular direction while effecting said projecting and capturing activities so as to obtain said captured image.

4. A surface-profiling method as claimed in claim 3 additionally comprising:
repeating said projecting and capturing activities at intervals along said vehicular direction to obtain a series of said captured images; and
deriving a profile of said surface in substantially said vehicular direction from said series of said captured images.

5. A surface-profiling method as claimed in claim 1 wherein said processing activity comprises:
producing an image signal in response to said image; and
correlating said image signal with a reference signal to produce said profile of said surface.

6. A surface-profiling method as claimed in claim 5 additionally comprising configuring said reference signal to correspond to said pattern projected by said projecting activity.

7. A surface-profiling method as claimed in claim 1 additionally comprising:
partitioning said image into at least one image region, wherein one said image region is responsive to a portion of said pattern projected upon said surface;
producing an image signal in response to said one image region;
correlating said image signal with a reference signal configured to correspond to said image region to produce a correlation signal; and
determining, in response to said correlation signal, a relative height of said surface upon which said portion of said pattern was projected.

8. A surface-profiling method as claimed in claim 1 additionally comprising:
partitioning said image into at least twenty-five image regions, wherein one of said image regions is responsive to a portion of said pattern projected upon said surface;
producing an image signal in response to said one image region;
correlating said image signal with a reference signal configured to correspond to said one image region to produce a correlation signal; and
determining, in response to said correlation signal, a relative height of said surface upon which said portion of said pattern was projected.

9. A surface-profiling method as claimed in claim 1 additionally comprising:
partitioning said image into at least twenty five image regions, wherein each of said image regions is responsive to a portion of said pattern projected upon said surface;
producing a plurality of image signals, wherein one of said image signals is produced in response to each of said image regions;
correlating each of said image signals with a reference-band signal configured to correspond to said each image region to produce a correlation signal;
determining, in response to each of said correlation signals, a relative height of said surface upon which said portion of said pattern was projected; and
producing said surface profile from said plurality of relative heights.

10. A surface-profiling method as claimed in claim 1 wherein said surface has a longitudinal direction and a transverse direction substantially perpendicular to said longitudinal direction, wherein said two-dimensional pattern has a length and a width, wherein said projecting activity projects said two-dimensional pattern so that said length of said pattern is substantially coincident with said longitudinal direction of said road surface and said width of said pattern is substantially coincident with said transverse direction of said road surface, and wherein said surface-profiling method additionally comprises:
partitioning said image into at least one image region, wherein said image region is responsive to a portion of said pattern projected upon said surface in said transverse direction;
producing an image signal in response to said one image region;
correlating said image signal with a reference signal configured to correspond to said image region to produce a correlation signal;
determining, in response to said correlation, a relative height of said surface upon which said portion of said pattern was projected;
repeating said projecting, capturing, partitioning, producing, correlating, and determining activities multiple times to produce a series of said relative heights of said road surface transverse profiles of said road surface; and
deriving a longitudinal profile of said road surface from said series of said relative heights of said road surface.

11. A surface-profiling system comprising:
a projector configured to project a two-dimensional pattern of alternating relatively lighter and relatively darker regions upon a surface from a first angle;
a camera configured to capture an image of said projected pattern from a second angle; and
a computer configured to produce a profile of said surface from said captured image.

12. A surface-profiling system as claimed in claim 11 wherein said pattern comprises:
at least three of said relatively lighter regions extending across a width of said pattern; and
at least two of said relatively darker regions extending across said width of said pattern, wherein each of said relatively darker regions is positioned between adjacent ones of said relatively lighter regions, and wherein said relatively lighter regions and said relatively darker regions together form a length of said pattern substantially perpendicular to said width thereof.

13. A surface-profiling system as claimed in claim 12 wherein:
said surface is a road surface having a longitudinal direction and a transverse direction substantially perpendicular to said longitudinal direction;
said two-dimensional pattern is projected upon said road surface so that said width of said pattern is substantially coincident with said transverse direction of said surface; and
said profile is a transverse profile of said road surface.

14. A surface-profiling system as claimed in claim 13 wherein:
said projector, camera, and processor are together configured to produce a series of said transverse profiles wherein each of said transverse profiles in said series is a transverse profile at a different distance along said longitudinal direction of said road surface; and
said computer is additionally configured to derive a longitudinal profile of said road surface from said series of said transverse profiles.

15. A surface-profiling system as claimed in claim 11 wherein:
said two-dimensional pattern has a width and a length;
said camera is a first camera configured to capture a first image of said pattern over a first portion of said width;
said system comprises a second camera configured to capture a second image of said pattern over a second portion of said width;
said computer is configured to integrate said first and second captured images and produce a profile of said surface therefrom.

16. A surface-profiling system as claimed in claim 11 wherein:
said projector is configured to project said pattern with said relatively lighter regions of substantially a predetermined monochromaticity; and
said camera is filtered to be sensitive to said relatively lighter regions of substantially said predetermined monochromaticity.

17. A surface-profiling system as claimed in claim 16 wherein:
said projector comprises a laser; and
said laser produces said relatively lighter regions of substantially said predetermined monochromaticity.

18. A surface-profiling system as claimed in claim 16 wherein said projector is a stroboscopic projector.

19. A surface-profiling method as claimed in claim 11 wherein said two-dimensional pattern is formed of a plurality of said relatively lighter regions separated by said relatively darker regions and projected over a width of said pattern, and has a length substantially perpendicular to said width.

20. A surface-profiling method as claimed in claim 11 wherein said two-dimensional pattern is configured to have a higher mathematical autocorrelation function in one direction.

21. A surface-profiling system comprising:
a vehicle configured to move in a vehicular direction upon a surface having a longitudinal direction and a transverse direction substantially perpendicular to said longitudinal direction, said vehicular direction being substantially coincident with said longitudinal direction;
a projector affixed to said vehicle and configured to project a series of two-dimensional patterns of alternating relatively lighter and relatively darker regions upon said surface as said vehicle moves in said vehicular direction, wherein said patterns are projected at a first angle substantially perpendicular to said surface, and wherein said patterns have a length and a width, said width being substantially coincident with said transverse direction;
a camera affixed to said vehicle and configured to capture images of said projected patterns from a second angle oblique to said surface as said vehicle moves in said vehicular direction; and
a computer configured to produce a transverse profile of said surface from each of said captured images and configured to derive a longitudinal profile of said surface from a plurality of said transverse profiles.
